(19) United States
(12) Patent Application Publication
(10) Pub. No.: US 2007/0154202 A1
(43) Pub. Date: Jul. 5, 2007

(54) Method and apparatus to facilitate correcting rolling shutter images

(76) Inventors: King F. Lee, Schaumburg, IL (US); Gregory A. Kujawa, St. Charles, IL (US); Bei Tang, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/324,810

(22) Filed: Jan. 4, 2006

(51) Int. Cl. G03B 17/00

(52) U.S. Cl. 396/153

(57) ABSTRACT

A first and a second image (401 and 501) containing a shared region of interest (400) are captured (201 and 202) using a rolling shutter mode of image capture. These two images are captured at different times, such that the second image follows the first image by a given amount of time. A corrected image is then formed (203) of the region of interest by modifying at least one of the first and second images as a function, at least in part, of the given amount of time that separates capture of the two images along with pixel capture delay times as correspond to the rolling shutter mode of image capture (the latter referring, by approach, to pixel row capture delay times as characterize the rolling shutter image capture process itself)

### TECHNICAL FIELD

This invention relates generally to captured image processing and more particularly to images captured using a rolling shutter mode of image capture.

### BACKGROUND

Digital image capture comprises a relatively well-understood field of endeavor. In many cases, and particularly when using complimentary metal oxide semiconductor-based image sensors, such image capture entails use of a so-called rolling shutter mode of operation. Instead of exposing every pixel in a given sensor array simultaneously, pixels are exposed one row (or column) at a time. Typically this entails using a relatively constant short time delay between each row (or column) exposure. This approach offers various benefits such as permitting a relatively efficient multiplexing of image capture circuitry. This, in turn, can aid in significantly reducing the price of a given image capture platform.

There are, however, certain problems that attend the use of a rolling shutter mode of operation. For example, a rolling shutter mode of operation can introduce undesirable artifacts under at least some operating circumstances. As each row (or column) in the sensor apparatus receives image exposures at slightly different times from one another, the resultant aggregate captured image will typically be distorted if an object in the field of view moves at an appreciable speed during the image capture process. Such distortion, in turn, may be objectionable both for aesthetic reasons and may be particularly troublesome when used in an object recognition application.

Such distortion can be at least substantially avoided by using a so-called global shutter. A global shutter will typically expose all pixels in the image capture sensor simultaneously. Unfortunately, this requires extra devices for each pixel as well as additional circuitry outside of the pixel array itself. This typically represents a significant increase in cost over the aforementioned rolling shutter mode of operation. Global shutter mechanisms also often tend to be specialized application platforms and often are unable to provide captured images in a useful variety of formats (as may correspond to size, resolution, and so forth).

### BRIEF DESCRIPTION OF THE DRAWINGS

The above needs are at least partially met through provision of the method and apparatus to facilitate correcting rolling shutter images described in the following detailed description, particularly when studied in conjunction with the drawings, wherein:

FIG. 1 comprises a depiction of an exemplary illustrative image captured using a prior art rolling shutter mode of operation as compared against the object itself;

FIG. 2 comprises a flow diagram as configured in accordance with various embodiments of the invention;

FIG. 3 comprises a flow diagram as configured in accordance with various embodiments of the invention;

FIG. 4 comprises an illustrative first captured image as configured in accordance with various embodiments of the invention;

FIG. 5 comprises an illustrative second captured image as configured in accordance with various embodiments of the invention;

FIG. 6 comprises an illustrative corrected image as configured in accordance with various embodiments of the invention; and

FIG. 7 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a first and a second image containing a shared region of interest are captured using a rolling shutter mode of image capture. These two images are captured at different times, such that the second image follows the first image by a given amount of time. A corrected image is then formed of the region of interest by modifying at least one of the first and second images as a function, at least in part, of the given amount of time that separates capture of the two images along with pixel capture delay times as correspond to the rolling shutter mode of image capture (the latter referring, by one approach, to pixel row capture delay times as characterize the rolling shutter image capture process itself).

By one optional approach, this image correction process further makes use of a motion metric that corresponds, in turn, to the content of the first and second images. More particularly, the image correction process can comprise, at least in part, a mapping approach that maps image pixels as a function of this motion metric as well as the aforementioned given amount of time and the pixel capture delay times.

So configured, the row-by-row distortion that rolling shutter image capture can introduce when capturing the image of a quickly moving object can be corrected to yield a corresponding corrected image. The resultant corrected image usually comprises a considerably improved and less distorted view of the object, both from an aesthetic viewpoint and as suitable subject matter to drive an object recognition process if desired.

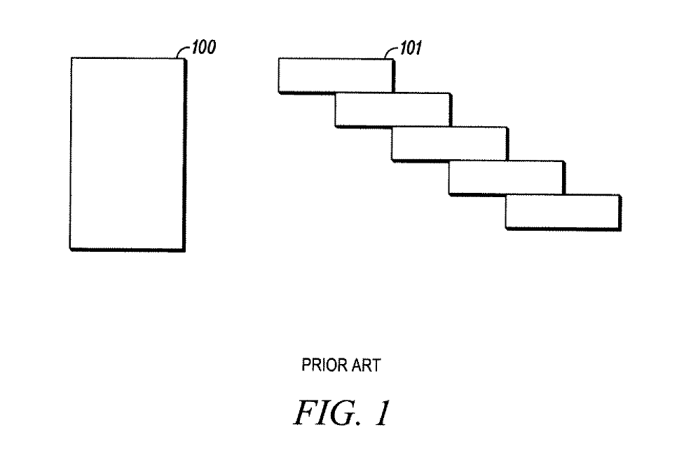

These and other benefits may become clearer upon making a thorough review and study of the following detailed description. Referring now to the drawings, and in particular to FIG. 1, it may be helpful to first characterize the kind of distortion that can occur when using rolling shutter techniques to capture an image of a moving object. In the example presented in FIG. 1, a rectangular-shaped object 100 is moving rapidly to the right. A corresponding captured image 101 of that object exhibits corresponding rolling shutter-based distortion. In particular, as each row of pixels is captured at a subsequent time following the capture of an earlier row, and as the object 100 moves a bit further to the right with each such capture event, the resultant aggregate captured image 101 comprises a series of displaced pixel rows. (The same thing happens in a vertical context when column-based rolling shutter techniques are applied.) The object 100 therefore appears skewed or slanted. The teachings presented herein are intended to facilitate removing at least some of this rolling shutter-based distortion.

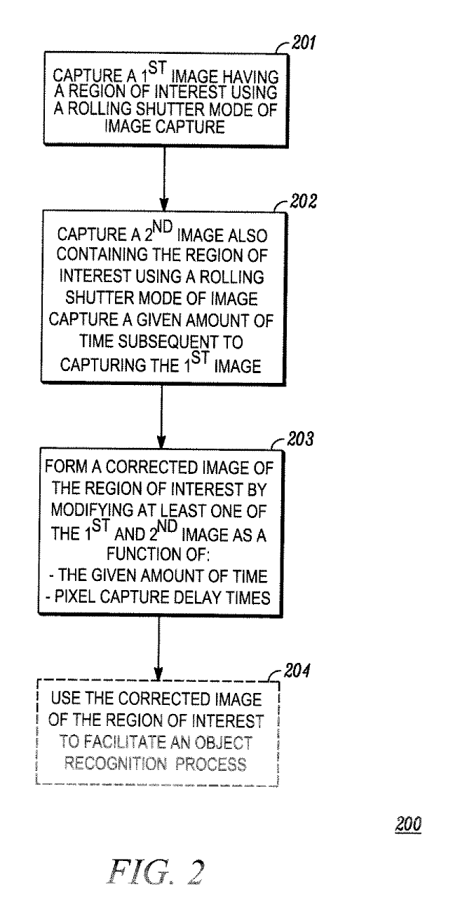

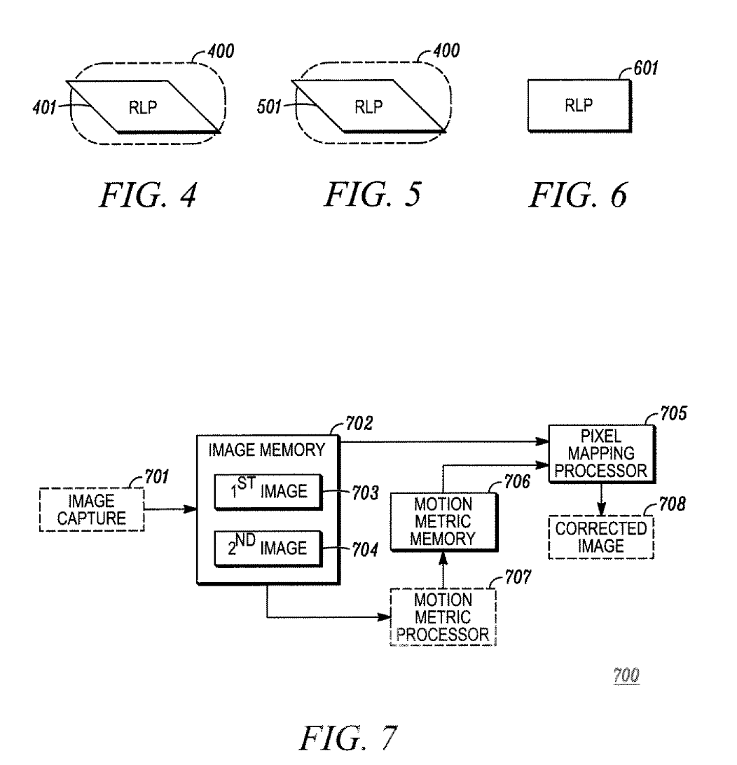

Referring now to FIG. 2, an exemplary process 200 comprises capturing 201 a first image that contains a region of interest using a rolling shutter mode of image capture. In this example, this rolling shutter mode of image capture comprises a row-by-row rolling shutter mode of image capture. If desired, however, these same principles could be applied in slightly modified form for use with, for example, a column-by-column rolling shutter mode of image capture. In this example, and referring momentarily to FIG. 4, this region of interest 400 comprises a license plate mounted to a moving automobile (not shown). This first image 401 therefore comprises a distorted image that exhibits rolling shutter-based distortion.

This process 200 also comprises capturing 202 a second image that also contains the region of interest using a rolling shutter mode of image capture, wherein the second image is captured at a given amount of time subsequent to capturing the first image. By one optional approach this second image is captured using the same rolling shutter mode of image capture as serves to capture the first image. This given amount of time may comprise, for example, a fraction of a second. Extremely fast or further delayed time windows may be appropriate, however, when seeking to capture an image given particular attendant circumstances regarding speed of the object, shutter speed, relative brightness or darkness, and so forth.

Referring momentarily to FIG. 5, as with the first captured imaged described above, this second captured image 501 will also typically comprise a distorted image of the object in the region of interest 400 due, again, to movement of the original object during the image capture process. By one approach, the duration of time between capturing the second and first images is sufficiently brief that the relative speed of the object being imaged will likely be substantially the same during both image capture processes.

Referring again to FIG. 2, this process 200 then provides for forming 203 a corrected image of the region of interest by modifying at least one of the first image and the second image as a function, at least in part, of the given amount of time (e.g., the period of time between the two image capture processes) and the pixel capture delay times as correspond to the rolling shutter mode of image capture. In this illustrative example the pixel capture delay times comprise the pixel row capture delay times (e.g., the amount of delay that separates the capture of each row of pixels as correspond to the rolling shutter mode of image capture).

Referring momentarily to FIG. 6, this corrected image 601 usually comprises a view of the object of interest sans much or all of the rolling shutter-based distortion as was evident in both the first and second captured images that were used to form this corrected image. Referring again to FIG. 2, in an optional approach, this process 200 can then provide for use 204 of this corrected image of the region of interest to facilitate an objection recognition process. As one illustrative example, the object recognition process can comprise a vehicular license plate recognition process as finds increasing use in various law enforcement and security settings. (Such vehicular license plate recognition processes are themselves understood in the art and therefore, for the sake of brevity, further elaboration will not be provided here.)

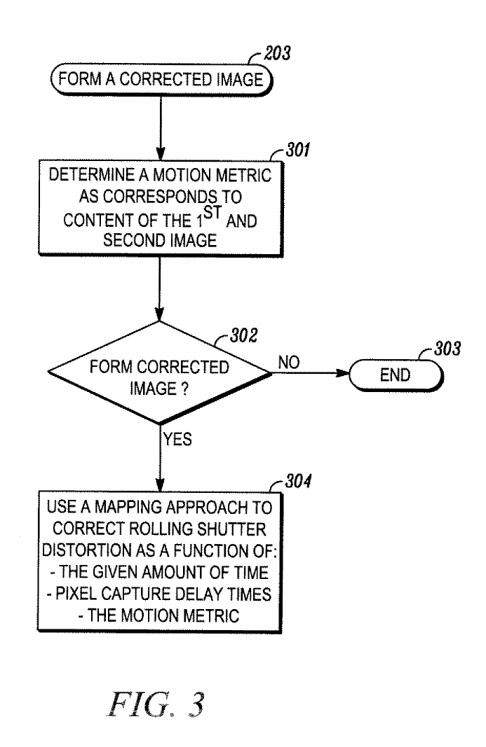

There are various ways to use the indicated information to form this corrected image. Referring now to FIG. 3, an optional approach to forming 203 a corrected image will be presented in more detail. By this approach to forming 203 a corrected image, one determines 301 a motion metric as corresponds to the content of the first and second distorted images. Such motion metrics and their manner of ascertainment are known in the art and typically correspond to apparent movement of a region of interest during a given amount of time. Such motion metrics are often characterized as a corresponding motion vector to facilitate, for example, their ready use in mathematical applications. In the case where, for example, an MPEG video sequence is available, the motion vector can be directly extracted, if desired, from the MPEG data stream itself. As the present teachings are not overly sensitive to the use of any particular motion vector value calculation method, and further as such methods are otherwise generally well known in the art, for the sake of brevity and the preservation of narrative focus additional detail regarding such methods will not be provided here.

In one optional approach, one then determines 302 whether the captured image (or images) requires distortion removal as per these teachings (e.g., whether sufficient distortion due to rolling shutter distortion has occurred to warrant providing a corrected image). For example, the object in question may not have been moving at the time the images were captured and hence no rolling shutter-based distortion may have occurred. By one approach, this determination 302 can comprise comparing the calculated motion metric with, for example, a predetermined threshold to obtain a corresponding result.

When this result corresponds to a first category of result (as when, for example, the first category of result indicates that rolling shutter-based distortion is likely present in the captured image(s)) this process then accommodates responsively then forming the corrected image of the region of interest by modifying at least one of the first and second captured images as described herein. When, however, this result corresponds to a second category of result (as when, for example, the second category of result indicates that rolling shutter-based distortion is likely not present in at least one of the captured images) this process will accommodate responsively not then forming such a corrected image. Instead, if desired, the already captured image can be used as an adequate representation of the region of interest.

Upon determining that correction should occur, this process may then use 304 a mapping approach to at least partially correct the rolling shutter distortion to provide a corrected image. This mapping approach may process the image information as a function, at least in part, of the given amount of time between capturing the two images, pixel capture delay times as correspond to the rolling shutter mode of image capture, and the above-mentioned motion metric. By one illustrative example, this mapping process implements a process represented by the expression:

$$I ( x , y ) = I ( x + ⌊ Δ x \frac{{T}_{r}}{{T}_{F}} y ⌋ , y + ⌊ Δ y \frac{{T}_{r}}{{T}_{F}} y ⌋ )$$

for all x, y within ROI
where:
I refers to an image pixel
Tᵣ refers to pixel capture delay time
T_{F} refers to given amount of time between image capture
x refers to the column index value
y refers to the row index value
Δx refers to the x component of a motion vector
Δy refers to the y component of a motion vector
└ ┘ denotes rounding towards a zero operator
ROI denotes the region of interest.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 7, an illustrative approach to such a platform will now be provided.

This apparatus 700 presumably operably couples to an image capture device (or devices) 701 of choice that serves to capture the images described herein. This image capture device 701 may comprise, for example, a complimentary metal oxide semiconductor-based image sensor as is known in the art. In any event, in this embodiment this image capture device 701 captures images using a rolling shutter mode of image capture operation (which may comprise either a row-by-row or column-by-column mode of rolling shutter mode of image capture operation).

An image memory 702 operably couples to the image capture device(s) 701 and receives the corresponding captured images. In this embodiment, this image memory 702 serves to store, for example, at least a first image 703 containing a region of interest, which first image 703 was captured via a rolling shutter mode of image capture and may therefore exhibit rolling shutter distortion due to relative movement of the region of interest and a second image 704 that also contains the region of interest, which second image 704 was also captured via a rolling shutter mode of image capture and may therefore also exhibit rolling shutter distortion. By one approach, as described above, this second image 704 was captured at a given amount of time subsequent to capture of the first image 703.

This apparatus 700 may also comprise a motion metric memory 706 having stored therein a motion metric that corresponds to an amount of apparent motion as corresponds to the region of interest as between the first image 703 and the second image 704. This motion metric can be developed via a method and platform of choice including but not limited to an optional motion metric processor 707 that operably couples to the image memory 702 to permit access to the corresponding image information.

A pixel mapping processor 705 operably couples to both the image memory 702 and to the motion metric memory 706 and is configured and arranged to form a corrected image 708 of the region of interest by modifying at least one of the first image 703 and the second image 704 as a function, at least in part, of the motion metric and pixel capture delay times as correspond to the rolling shutter mode of image capture. This pixel mapping processor 705 may also make use of the aforementioned given amount of time that separates the image capture events as correspond to the first and second images. By one approach this comprises shifting pixels as comprise one of the images in accordance with the mapping expression set forth above.

Those skilled in the art will recognize and understand that such an apparatus 700 may be comprised of a plurality of physically distinct elements as is suggested by the illustration shown in FIG. 7. It is also possible, however, to view this illustration as comprising a logical view, in which case one or more of these elements can be enabled and realized via a shared platform (as but one illustration of this point, the image memory 702 and the motion metric memory 706 can share a common memory platform). It will also be understood that such a shared platform may comprise a wholly or at least partially programmable platform as are known in the art.

So configured, a relatively undistorted image can be provided notwithstanding only the availability of distorted images. This, in turn, permits a wider range of applications for rolling shutter-based image capture platforms as this relatively inexpensive approach to image capture can now be successfully employed in application settings that include rapidly moving objects. These teachings are implementable in a relatively cost effective manner and are even suitable for retrofitting for use in an already deployed system if desired.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, any number of additional captured images could be used to supplement the above-mentioned first and second captured images to provide additional information regarding the motion metric, the region of interest itself, and so forth. It will also be understood that column-based rolling shutter image capture and column-based mapping to compensate for corresponding distortion is also within the scope of these teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

We claim:

1. A method comprising:
capturing a first image containing a region of interest using a rolling shutter mode of image capture;
capturing a second image that also contains the region of interest using a rolling shutter mode of image capture, wherein capturing the second image begins a given amount of time subsequent to capturing the first image;
forming a corrected image of the region of interest by modifying at least one of the first image and the second image as a function, at least in part, of:
the given amount of time; and
pixel capture delay times as correspond to the rolling shutter mode of image capture.

2. The method of claim 1 wherein capturing a first image and capturing a second image comprises capturing the first image and the second image using a complimentary metal oxide semiconductor-based image sensor.

3. The method of claim 1 wherein the rolling shutter mode of image capture comprises a row-by-row rolling shutter mode of image capture.

4. The method of claim 1 wherein the pixel capture delay times comprise pixel row capture delay times.

5. The method of claim 1 wherein forming a corrected image of the region of interest by modifying at least one of the first image and the second image as a function, at least in part, of the given amount of time and pixel capture delay times as correspond to the rolling shutter mode of image capture further comprises determining a motion metric as corresponds to apparent movement of the region of interest during the given amount of time, wherein the motion metric comprises a motion vector.

6. The method of claim 5 wherein forming a corrected image of the region of interest by modifying at least one of the first image and the second image as a function, at least in part, of the given amount of time and pixel capture delay times as correspond to the rolling shutter mode of image capture further comprises modifying pixels as comprise the image to be modified in accordance with the expression:
$$I ( x , y ) = I ( x + ⌊ Δ x \frac{{T}_{r}}{{T}_{F}} y ⌋ , y + ⌊ Δ y \frac{{T}_{r}}{{T}_{F}} y ⌋ )$$
for all x, y within ROI
where:
I refers to an image pixel
Tᵣ refers to pixel capture delay time
T_{F} refers to given amount of time between image capture
x refers to the column index value
y refers to the row index value
□x refers to the x component of a motion vector
□y refers to the y component of a motion vector [symbol] [symbol]
denotes rounding towards a zero operator
ROI denotes the region of interest.

7. The method of claim 1 wherein forming a corrected image of the region of interest by modifying at least one of the first image and the second image as a function, at least in part, of the given amount of time and pixel capture delay times as correspond to the rolling shutter mode of image capture further comprises determining a motion metric as corresponds to apparent movement of the region of interest during the given amount of time.

8. The method of claim 7 further comprising:
comparing the motion metric with a predetermined threshold to obtain a result;
when the result corresponds to a first category of result, responsively then forming the corrected image of the region of interest by modifying at least one of the first image and the second image;
when the result corresponds to a second category of result, responsively not then forming a corrected image of the region of interest.

9. The method of claim 1 further comprising:
using the corrected image of the region of interest to facilitate an object recognition process.

10. The method of claim 9 wherein the object recognition process comprises a vehicular license plate recognition process.

11. A method of facilitating compensation of a distorted image that has been captured using a rolling shutter mode of image capture that introduced rolling shutter distortion, comprising:
capturing a second image using a rolling shutter mode of image capture, wherein capturing the second image begins a given amount of time subsequent to capturing the distorted image;
determining a motion metric as corresponds to content of the distorted image and the second image;
determining to form a corrected image;
using a mapping approach to at least partially correct the rolling shutter distortion to provide a corrected image, wherein the mapping approach processes image information as a function, at least in part, of:
the given amount of time;
pixel capture delay times as correspond to the rolling shutter mode of image capture; and
the motion metric.

12. The method of claim 11 wherein the given amount of time substantially comprises a fraction of a second.

13. The method of claim 11 wherein determining to form a corrected image comprises determining whether sufficient distortion due to rolling shutter distortion has occurred to warrant providing a corrected image.

14. The method of claim 11 wherein the mapping approach implements a process represented by:
$$I ( x , y ) = I ( x + ⌊ Δ x \frac{{T}_{r}}{{T}_{F}} y ⌋ , y + ⌊ Δ y \frac{{T}_{r}}{{T}_{F}} y ⌋ )$$
for all x, y within ROI
where:
I refers to an image pixel
Tᵣ refers to pixel capture delay time
T_{F} refers to given amount of time between image capture
x refers to the column index value
y refers to the row index value
□x refers to the x component of a motion vector
□y refers to the y component of a motion vector [symbol] [symbol]
denotes rounding towards a zero operator
ROI denotes the region of interest.

15. An apparatus comprising:
an image memory operably coupled to receive captured images and having stored therein:
a first image containing a region of interest, which first image was captured via a rolling shutter mode of image capture and may therefore exhibit rolling shutter distortion due to relative movement of the region of interest;
a second image that also contains the region of interest, which second image was captured via a rolling shutter mode of image capture at a given amount of time subsequent to when the first image was captured;
a motion metric memory having stored therein a motion metric that corresponds to an amount of apparent motion as corresponds to the region of interest as between the first image and the second image;
a pixel mapping processor that is operably coupled to the image memory and the motion metric memory and that is configured and arranged to form a corrected image of the region of interest by modifying at least one of the first image and the second image as a function, at least in part, of:
the motion metric; and
pixel capture delay times as correspond to the rolling shutter mode of image capture.

16. The apparatus of claim 15 wherein the motion metric comprises a motion vector value.

17. The apparatus of claim 15 wherein the pixel capture delay times comprise pixel row capture delay times.

18. The apparatus of claim 15 wherein the pixel mapping processor comprises means for forming a corrected image of the region of interest by modifying at least one of the first image and the second image as a function, at least in part, of:
the motion metric; and
pixel capture delay times as correspond to the rolling shutter mode of image capture.

19. The apparatus of claim 15 wherein the pixel mapping processor comprises means for shifting pixels as comprise an image to be modified in accordance with the expression:
$$I ( x , y ) = I ( x + ⌊ Δ x \frac{{T}_{r}}{{T}_{F}} y ⌋ , y + ⌊ Δ y \frac{{T}_{r}}{{T}_{F}} y ⌋ )$$
for all x, y within ROI
where:
I refers to an image pixel
Tᵣ refers to pixel capture delay time
T_{F} refers to given amount of time between image capture
x refers to the column index value
y refers to the row index value
□x refers to the x component of a motion vector
□y refers to the y component of a motion vector [symbol] [symbol]
denotes rounding towards a zero operator
ROI denotes the region of interest.
